(19) United States
(12) Patent Application Publication
(10) Pub. No.: US 2020/0314043 A1
(43) Pub. Date: Oct. 1, 2020

(54) METHOD FOR SCHEDULED TRANSMISSION OF MESSAGE, INSTANT MESSAGING DEVICE, AND COMPUTER PROGRAM PRODUCT FOR SCHEDULED TRANSMISSION OF A MESSAGE

(71) Applicant: Letstalk Technology Limited, Taipei City (TW)

(72) Inventors: Chan-Guan KOH, Taipei City (TW); Chun-Hao CHEN, Taipei City (TW); Tzu-Ying WANG, Taipei City (TW); Sheng-Yen FANG, Taipei City (TW); Chien-Cheng LU, Taipei City (TW); I-Yun CHAO, Taipei City (TW)

(21) Appl. No.: 16/460,670

(22) Filed: Jul. 2, 2019

(30) Foreign Application Priority Data
Mar. 29, 2019 (TW) 108111341

(51) Int. Cl. H04L 12/58; G06F 3/0481; H04L 29/06; G06F 3/0482

(52) U.S. Cl. CPC H04L 51/046; G06F 3/0482; H04L 65/1089; G06F 3/04817

(57) ABSTRACT

A method for scheduled transmission of a message is to be implemented by an instant messaging (IM) device, and includes: executing IM software and providing a graphical user interface (GUI) which includes a chat interface for a chat session, the chat interface being established in advance by the IM software; when it is determined that a message is inputted in an input field of the chat interface and that a prearrangement icon of the chat interface is selected, presenting a date-and-time picker in the GUI for setting a scheduled time; generating a scheduled task when it is determined that the scheduled time has been set; and sending the message corresponding to the scheduled task to the chat session when it is determined that the scheduled time corresponding to the scheduled task has arrived.

### CROSS-REFERENCE TO RELATED APPLICATION

This application claims priority of Taiwanese Invention Patent Application No. 108111341, filed on Mar. 29, 2019.

### FIELD

The disclosure relates to transmission of a message, and more particularly to a method for scheduled transmission of a message.

### BACKGROUND

It is often difficult for one to remember what has been planned. For example, for being interrupted by something, a person may forget to send a message that was originally planned to be sent out, such as a reminder email for reminding other colleague(s) to handle specific tasks, or to send a greeting message to a good friend for his/her birthday. Therefore, a method for scheduled transmission of a message is demanded.

### SUMMARY

Therefore, an object of the disclosure is to provide a method for scheduled transmission of a message.

According to one aspect of the disclosure, the method is to be implemented by an instant messaging (IM) device that is installed with IM software. The method includes steps of:

executing the IM software and providing a graphical user interface which includes a chat interface for a chat session, the chat interface being established in advance by the IM software;

when it is determined that a message is inputted in an input field of the chat interface and that a prearrangement icon of the chat interface is selected, presenting a date-and-time picker in the graphical user interface for setting a scheduled time;

generating a scheduled task when it is determined that the scheduled time has been set, the scheduled task corresponding to sending the message at the scheduled time; and

sending the message corresponding to the scheduled task to the chat session when it is determined that the scheduled time corresponding to the scheduled task has arrived.

According to another aspect of the disclosure, an instant messaging (IM) device is installed with IM software. The IM device includes a storage configured to store the IN software, an input unit configured to be operated to generate a user input, an output unit, a communication unit, and a processor electrically connected to the storage, the input unit, the output unit and the communication unit. The processor is configured to execute the IM software, control, in response to the user input, the output unit to display a graphical user interface which includes a chat interface for a chat session, where the chat interface is established in advance by the 1M software, control, when it is determined that a message is inputted in an input field of the chat interface and that a prearrangement icon of the chat interface is selected, the output unit to present a date-and-time picker in the graphical user interface for setting a scheduled time, generate a scheduled task that corresponds to sending the message at the scheduled time when it is determined that the scheduled time has been set, and store the message corresponding to the scheduled task in the storage, retrieve the message corresponding to the scheduled task stored in the storage when it is determined that the scheduled time corresponding to the scheduled task has arrived, and send the message thus retrieved to the chat session via the communication unit.

According to still another aspect of the disclosure, a computer program product is adapted for scheduled transmission of a message. The computer program product includes a non-transitory computer readable storage medium having instant messaging (IM) software stored therewith. The IM software, when being executed by a computer, causes the computer to:

provide a graphical user interface which includes a chat interface for a chat session, the chat interface being established in advance by the IM software;

present a date-and-time picker in the graphical user interface for setting a scheduled time when it is determined that a message is inputted in an input field of the chat interface and that a prearrangement icon of the chat interface is selected;

generate a scheduled task when it is determined that the scheduled time has been set, the scheduled task corresponding to sending the message at the scheduled time; and

send the message corresponding to the scheduled task to the chat session when it is determined that the scheduled time corresponding to the scheduled task has arrived.

### BRIEF DESCRIPTION OF THE DRAWINGS

Other features and advantages of the disclosure will become apparent in the following detailed description of the embodiment with reference to the accompanying drawings, of which:

FIG. 1 is a flow chart illustrating an embodiment of a method for scheduled transmission of a message according to the disclosure;

FIG. 2 is a block diagram illustrating an embodiment of an instant messaging (IM) device according to the disclosure;

FIG. 3 is a schematic diagram illustrating an embodiment of a chat interface that is presented in a graphical user interface provided by the IM device through executing IM software;

FIG. 4 is a schematic diagram illustrating an embodiment of a date-and-time picker for setting a scheduled time that is presented in the graphical user interface provided by the IM device;

FIG. 5 is a schematic diagram illustrating an embodiment of a confirmation dialog that is presented in the graphical user interface provided by the IM device;

FIG. 6 is a schematic diagram illustrating an embodiment of a chat list that is presented in the graphical user interface provided by the IM device;

FIG. 7 is a schematic diagram illustrating an embodiment of a schedule list that contains multiple scheduled tasks and that is presented in the graphical user interface provided by the IM device; and

FIG. 8 is a schematic diagram illustrating an embodiment of a repetition period picker for designating a repetition period that is presented in the graphical user interface provided by the IM device.

### DETAILED DESCRIPTION

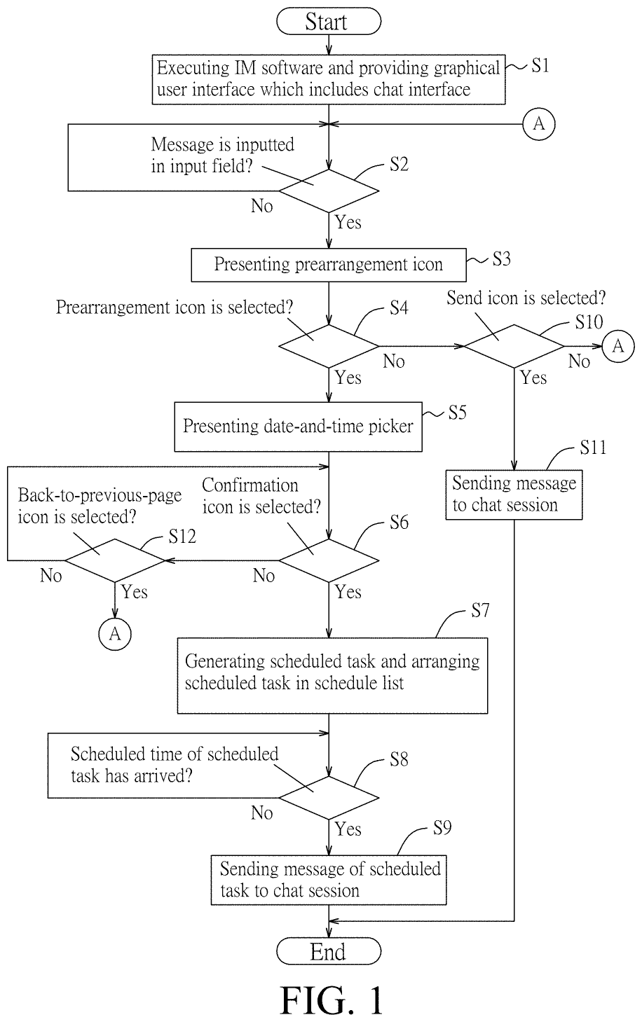

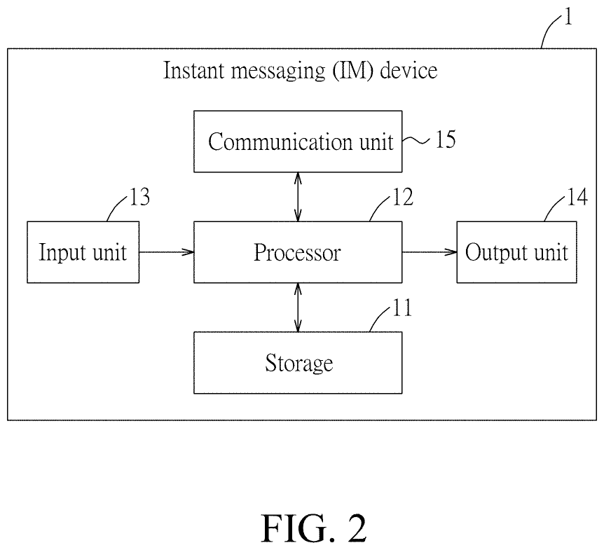

Referring to FIG. 1, an embodiment of a method for scheduled transmission of a message according to the disclosure is illustrated. The method is to be implemented by an instant messaging (IM) device 1 that is installed with IM software as shown in FIG. 2. The IM device 1 may be implemented to be a smartphone, a desktop computer, a laptop computer, a notebook computer or a tablet computer, but is not limited thereto.

The IM device 1 includes a storage 11 configured to store the IM software, an input unit 13 configured to be operated to generate a user input, an output unit 14, a communication unit 15, and a processor 12 electrically connected to the storage 11, the input unit 13, the output unit 14 and the communication unit 15.

The storage 11 may be implemented by a flash memory, a hard disk drive (HDD) , a solid state disk (SSD) , an electrically-erasable programmable read-only memory (EEPROM) or any other non-volatile memory devices, but is not limited thereto.

The processor 12 may be implemented by a central processing unit (CPU), a microprocessor or any circuit configurable/programmable in a software manner and/or hardware manner to implement functionalities discussed in this disclosure.

The input unit 13 may be implemented to be a keyboard, or a mouse, but is not limited thereto.

The output unit 14 may be implemented to be a display, but is not limited thereto. For example, in some embodiments, the input unit 13 and the output unit 14 may be integrated as a touchscreen.

The communication unit 15 is implemented to be a network interface controller or a wireless transceiver that supports wired/wireless communication standards such as cellular network technology standards, but is not limited thereto.

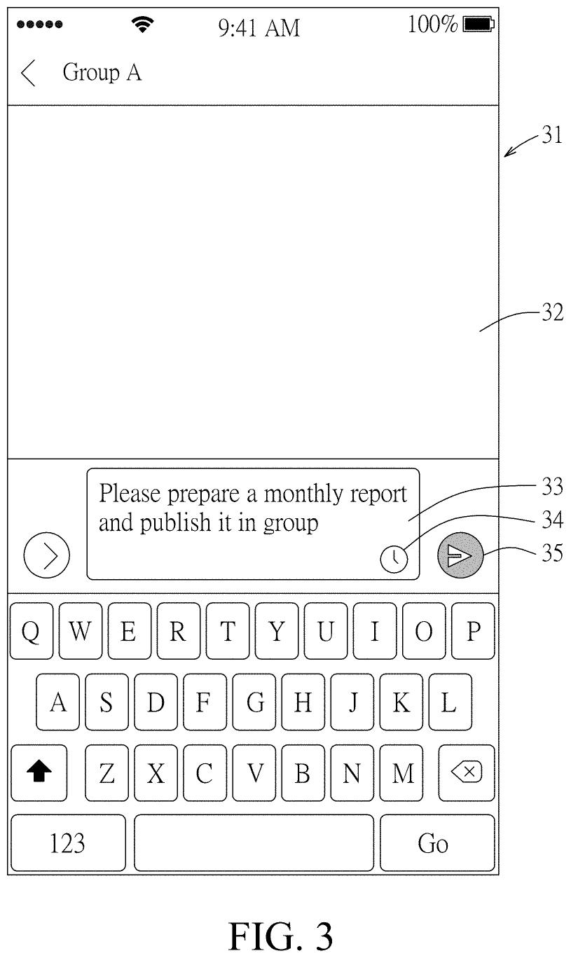

Referring to FIG. 3, the processor 12 is configured to execute the 1M software, and to control, in response to the user input, the output unit 14 to display a graphical user interface which includes a chat interface for a chat session; the chat interface is established/created in advance by the IM software. In this embodiment, the IM device 1 is exemplarily implemented by a smartphone that includes a touchscreen and that is communicable with an IM server (not shown) over the Internet by executing the IM software so that a user of the IM device 1 is able to exchange messages with other members in the chat session.

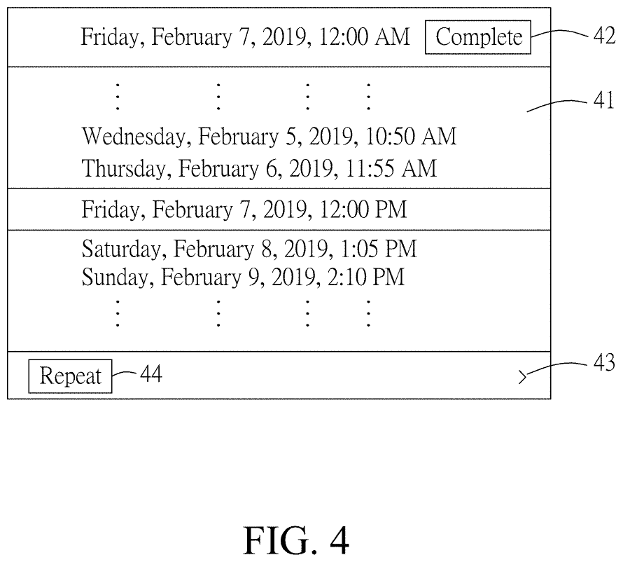

When it is determined that a message is inputted in an input field 33 of the chat interface and that a prearrangement icon 34 of the chat interface is selected, the processor 12 is configured to control the output unit 14 to present a date-and-time picker 41 in the graphical user interface for setting a scheduled time, as shown in FIG. 4.

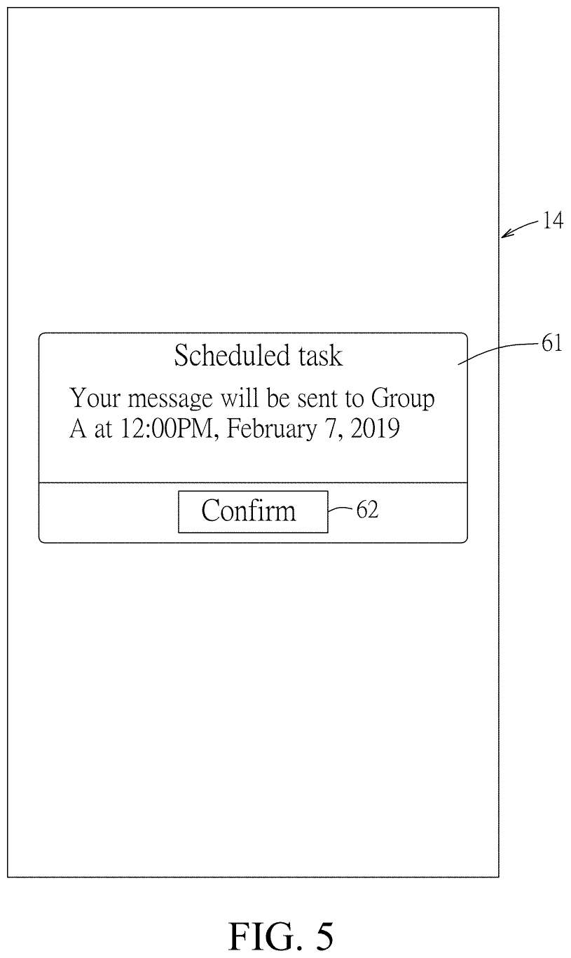

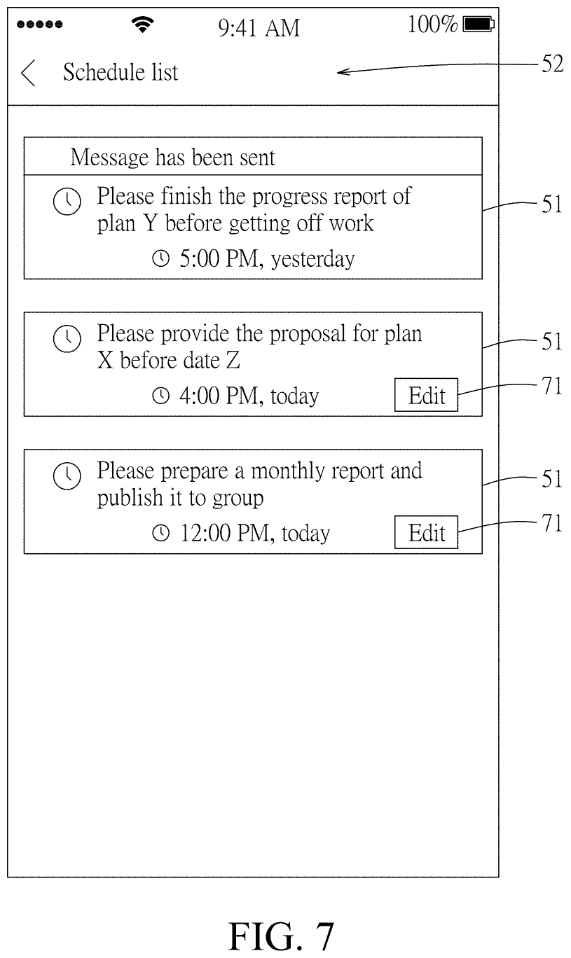

Referring to FIG. 5, when it is determined that the scheduled time has been set, the processor 12 is configured to generate a confirmation dialog 61 in the graphical user interface, and to control the output unit 14 to present the confirmation dialog 61 in the graphical user interface, where the confirmation dialog 61 requests approval to send the message to the chat session at the scheduled time. In this embodiment, the scheduled time is determined as being set by selecting an icon 42 that is marked with “Complete” and that is located at an upper right corner of the date-and-time picker 41 as shown in FIG. 4. When it is further determined that a confirmation icon 62 contained in the confirmation dialog 61 for approval to send the message has been selected (see FIG. 5) , the processor 12 is configured to generate a scheduled task 51 that corresponds to sending the message at the scheduled time, as shown in FIG. 7, to arrange the scheduled task 51 in a schedule list 52 as shown in FIG. 7, and to store the message in the storage 11.

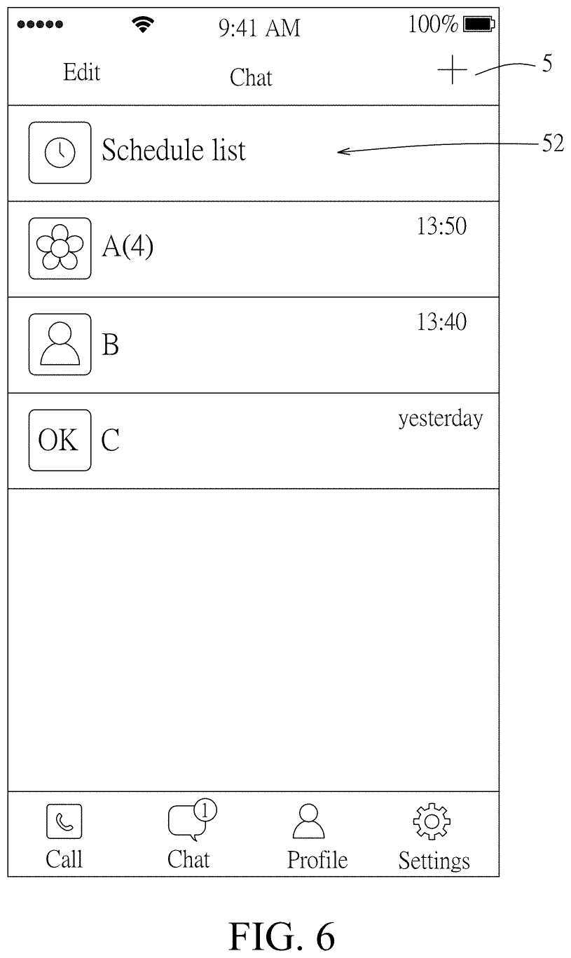

Referring to FIG. 6, the processor 12 is configured to control the output unit 14 to present in the graphical user interface a chat list 5 that contains an option corresponding to the schedule list 52 and that is created by the IM software. Presentation of the option corresponding to the schedule list 52 in the graphical user interface is located at the top of the chat list 5 and is marked with a clock illustration. Chatting parties (e.g., Group A, individual B and Individual C) with whom the user recently chatted are listed on the chat list 5.

When it is determined that the option corresponding to the schedule list 52 is selected, the processor 12 is configured to control the output unit 14 to present the schedule list 52 in the graphical user interface, as shown in FIG. 7. Presentation of the schedule list 52 contains contents of the scheduled task 51 (more than one is illustrated in FIG. 7) which include the message to be sent to the chat session at the scheduled time, and further contains an edit icon 71 which corresponds to the scheduled task 51 . Moreover, when the user intends to change the scheduled time at which the message corresponding to the scheduled task 51 is to be sent, the user may operate the input unit 13 to select (e g. by clicking) the edit icon 71 corresponding to the scheduled task 51. When it is determined that the edit icon 71 corresponding to the scheduled task 51 is selected, the processor 12 is configured to control the output unit 14 to present the date-and-time picker 41 once again in the graphical user interface for resetting the scheduled time. When it is determined that the scheduled time has been reset via the date-and-time picker 41 shown in FIG. 4 by operating the input unit 13 to select the icon 42 that is marked with “Complete”, the processor is configured to update the scheduled time corresponding to the scheduled task 51. When it is determined that the scheduled time corresponding to the scheduled task 51 has arrived, the processor 12 is configured to retrieve the message corresponding to the scheduled task 51 stored in the storage 11, and to send the message to the chat session (by sending the message to the IM server) via the communication unit 15. When it is determined that the message corresponding to the scheduled task 51 has been sent to the chat session, the scheduled task 51 will be marked as “Message has been sent” as shown in FIG. 7.

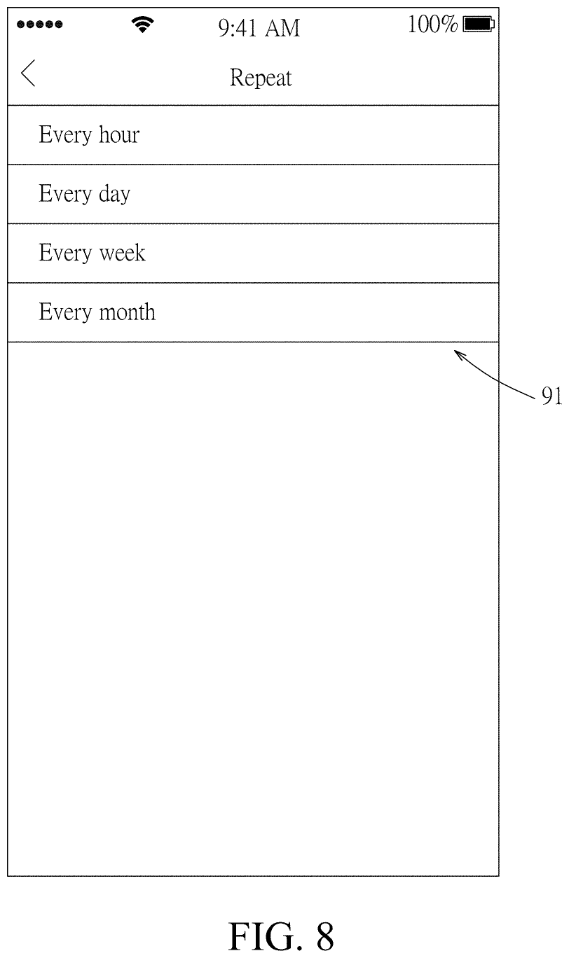

Moreover, referring to FIG. 4, the processor 12 is configured to control the output unit 14 to present a repeat icon 44 on the date-and-time picker 41 to allow the user to send the same message periodically, e.g., every hour, every day, every week or every year, to the chat session. When it is determined that the repeat icon 44 is selected by operating the input unit 13, the processor 12 is configured to control the output unit 14 to present in the graphical user interface a repetition period picker for the user to designate a repetition period, as shown in FIG. 8. Possible options in the repetition period picker may include every hour, every day, every week, every month, and every year. In this embodiment, the options in the repetition period picker include every hour, every day, every week and every month Whenever it is determined that the scheduled time corresponding to the scheduled task 51 has arrived or every repetition period after the scheduled time has elapsed, the processor 12 is configured to send the message corresponding to the scheduled task 51 to the chat session. For example, in a scenario that the scheduled time is set as 12:00 PM, Friday, Feb. 7, 2019, the processor 12 will send the message to the chat session at 12:00 PM, Friday, Feb. 7, 2019 for the first time, and when the repetition period is designated to be every hour, the processor 12 will send the message repeatedly every hour since the first time, i.e., at 1:00 PM, 2:00 PM, and so on; when the repetition period is designated to be every day, the processor 12 will send the message repeatedly every day since the first time, i.e., at 12:00 PM on February 8, at 12:00 PM on February 9, and so on; when the repetition period is designated to be every week, the processor 12 will send the message repeatedly at 12:00 PM every Friday since the first time; when the repetition period is designated to be every month, the processor 12 will send the message repeatedly every month since the first time, i.e., at 12:00 PM on the seventh day of every month.

Referring back to FIG. 1, the method for scheduled transmission of a message according to the disclosure includes steps S1 to S12 described as follows.

In step S1, based on a user input via the input unit 13, the processor 12 of the IM device 1 executes the IM software, provides the graphical user interface, and according to user's selection of one of individuals or groups in a friend list which is established in advance by the IM software, opens the chat session corresponding to the individual or group thus selected in the graphical user interface. Taking the chat session for “Group A” that has four members and that is shown in FIG. 3 as an example, the chat interface 31 in the graphical user interface includes a chat window 32 and the input field 33. The user is able to operate the input unit 13 to input a message in the input field 33 so as to publish the message in (or send the message to) the chat session.

In step S2, the processor 12 determines whether a message is inputted in the input field 33 of the chat interface 31. When it is determined that a message (e. g. , “Please prepare a monthly report and publish it in group” as shown in FIG. 3) is inputted in the input field 33 of the chat interface 31, a flow of procedure of the method proceeds to step S3. Otherwise, the flow stays in step S2.

In step S3, the processor 12 controls the output unit 14 to present the prearrangement icon 34 in the chat interface 31. The prearrangement icon 34 may be implemented to be located in the input field 33 or at a location of the chat interface 31 that is convenient for the user to select. Then, the flow proceeds to step S4.

In step S4, the processor 12 determines whether the prearrangement icon 34 is selected. The determination is made based on a signal that corresponds to operation of the prearrangement icon 34 and that is transmitted by the input unit 13. It should be noted that selecting the prearrangement icon 34 means that the message is not to be published (or be sent) right away, but instead is to be scheduled for transmission at a later time. When it is determined that the prearrangement icon 34 is selected, the flow proceeds to step S5. Otherwise, the flow proceeds to step S10.

In step S5, the processor 12 controls the output unit 14 to present the date-and-time picker 41 in the graphical user interface, as shown in FIG. 4, for the user to set a scheduled time (e.g., 12:00 PM, Friday, Feb. 7, 2019) via the input unit 13 (e.g., a touchscreen). Then, the flow proceeds to step S6.

In step S6, the processor 12 determines whether the scheduled time has been set. When it is determined that the scheduled time has been set, the processor 12 generates a confirmation dialog 61, and controls the output unit 14 to present the confirmation dialog 61 in the graphical user interface, as shown in FIG. 5. The confirmation dialog 61 requests approval to send the message to the chat session of “Group A” at the scheduled time. When it is determined that the confirmation icon 62 contained in the confirmation dialog 61 for approval to send the message has been selected by the user via the input unit 13, the flow proceeds to step S7. On the other hand, when it is determined that the scheduled time has not been set, the flow proceeds to step S12. In one embodiment, the confirmation procedure by use of the confirmation dialog 61 may be omitted.

In step S7, the processor 12 generates a scheduled task 51 and arranges the scheduled task 51 in the schedule list 52, wherein the scheduled task 51 corresponds to sending the message at the scheduled time. Thereafter, the processor 12 stores the message corresponding to the scheduled task 51 in the storage 11. The scheduled task can be rescheduled before arrival of the scheduled time.

In step S8, the processor 12 determines whether the scheduled time corresponding to the scheduled task 51 has arrived. When it is determined that the scheduled time corresponding to the scheduled task 51 has arrived, the flow proceeds to step S9. Otherwise, the flow stays in S8.

In step S9, the processor 12 retrieves the message that is stored in the storage 11 and that corresponds to the scheduled task 51, and sends the retrieved message to the chat session via the communication unit 15. Specifically, the message is transmitted to the IM server (not shown) via the communication unit 15, and the 1M server then publishes the message in the chat session so as to enable each member of the chat session to receive the message. Therefore, the user does not have to worry about forgetting to send the message at the scheduled time.

In step S10, the processor 12 determines whether a send icon 35 as shown in FIG. 3 is selected. When it is determined that the send icon 35 is selected, the flow proceeds to step S11. Otherwise, the flow returns to step S2.

In step S11, the processor 12 sends the message to the chat session via the communication unit 15 and the IM server.

In step S12, the processor 12 determines whether a back-to-previous-page icon 43 as shown in FIG. 4 is selected. When it is determined that the back-to-previous-page icon 43 is selected, designation of the scheduled time is canceled, and the flow returns to step S2. Otherwise, the flow returns to step S6.

In one embodiment, a computer program product according to the disclosure is adapted for scheduled transmission of a message. The computer program product includes a non-transitory computer readable storage medium having instant messaging (IM) software stored therewith. When being executed by a computer, the IM software causes the computer to provide a graphical user interface which includes a chat interface 31 for a chat session; the chat interface 31 is established/created in advance by the IM software. When it is determined that a message is inputted in an input field 33 of the chat interface 31 and that a prearrangement icon 34 of the chat interface 31 is selected, the IM software causes the computer to present a date-and-time picker 41 in the graphical user interface for setting a scheduled time. When it is determined that the scheduled time has been set, the IM software causes the computer to generate a scheduled task 51 and arrange the scheduled task 51 in a schedule list 52. The scheduled task 51 is to send the message at the scheduled time . When it is determined that the scheduled time corresponding to the scheduled task 51 has arrived, the IM software causes the computer to send the message corresponding to the scheduled task 51 to the chat session.

In summary, the method for scheduled transmission of a message according to the disclosure utilizes the IM device 1 which is installed with the IM software to provide the graphical user interface which includes the chat interface , to generate and arrange a scheduled task which corresponds to sending an edited message at a scheduled time in the schedule list, and when it is determined that the scheduled time corresponding to the scheduled task has arrived, to send the edited message corresponding to the scheduled task to the chat session. Therefore, scheduled transmission of a message may be realized and the trouble of forgetting to send a message may be alleviated.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for scheduled transmission of a message, to be implemented by an instant messaging (IM) device that is installed with IM software, the method comprising:
executing the IM software and providing a graphical user interface which includes a chat interface for a chat session, the chat interface being established in advance by the IM software;
when it is determined that a message is inputted in an input field of the chat interface and that a prearrangement icon of the chat interface is selected, presenting a date-and-time picker in the graphical user interface for setting a scheduled time;
when it is determined that the scheduled time has been set, generating a scheduled task, the scheduled task corresponding to sending the message at the scheduled time; and
when it is determined that the scheduled time corresponding to the scheduled task has arrived, sending the message corresponding to the scheduled task to the chat session.

2. The method as claimed in claim 1, further comprising:
when it is determined that the scheduled time has been set, generating a confirmation dialog, and presenting the confirmation dialog in the graphical user interface, the confirmation dialog requesting approval to send the message to the chat session at the scheduled time; and
wherein generating the scheduled task is performed when it is determined that a confirmation icon contained in the confirmation dialog for approval to send the message has been selected.

3. The method as claimed in claim 1, further comprising:
arranging the scheduled task in a schedule list;
presenting in the graphical user interface a chat list that contains an option corresponding to the schedule list and that is created by the IM software;
when it is determined that the option corresponding to the schedule list is selected, presenting the schedule list in the graphical user interface, presentation of the schedule list containing contents of the scheduled task which include the message to be sent to the chat session at the scheduled time and further containing an edit icon which corresponds to the scheduled task;
when it is determined that the edit icon corresponding to the scheduled task is selected, presenting the date-and-time picker in the graphical user interface for resetting the scheduled time; and
when it is determined that the scheduled time has been reset via the date-and-time picker, updating the scheduled time corresponding to the scheduled task.

4. The method as claimed in claim 1, wherein:
the presenting the date-and-time picker includes
presenting a repeat icon on the date-and-time picker, and
when it is determined that the repeat icon is selected, presenting a repetition period picker in the graphical user interface for designating a repetition period; and
the sending the message corresponding to the scheduled task to the chat session includes sending, when it is determined that the scheduled time corresponding to the scheduled task has arrived or whenever a repetition period has elapsed after the scheduled time, the message corresponding to the scheduled task to the chat session.

5. The method as claimed in claim wherein the repetition period picker include one of an option of every hour, an option of every day, an option of every week, an option of every month, an option of every year and any combination thereof.

6. An instant messaging (IM) device that is installed with IM software, said IM device comprising:
a storage configured to store the IM software;
an input unit configured to be operated to generate a user input;
an output unit;
a communication unit; and
a processor electrically connected to said storage, said input unit, said output unit and said communication unit, and configured to
execute the IM software,
in response to the user input, control said output unit to display a graphical user interface which includes a chat interface for a chat session, the chat interface being established in advance by the IM software,
when it is determined that a message is inputted in an input field of the chat interface and that a prearrangement icon of the chat interface is selected, control said output unit to present a date-and-time picker in the graphical user interface for setting a scheduled time,
when it is determined that the scheduled time has been set, generate a scheduled task that corresponds to sending the message at the scheduled time, and store the message in said storage,
when it is determined that the scheduled time corresponding to the scheduled task has arrived, retrieve the message corresponding to the scheduled task stored in said storage, and send the message thus retrieved to the chat session via said communication unit.

7. The IM device as claimed in claim 6, wherein said processor is further configured to:
generate a confirmation dialog in the graphical user interface when it is determined that the scheduled time has been set, the confirmation dialog requesting approval to send the message to the chat session at the scheduled time;
control said output unit to present the confirmation dialog in the graphical user interface; and
when it is further determined that a confirmation icon contained in the confirmation dialog for approval to send the message has been selected, generate the scheduled task.

8. The IM device as claimed in claim 6, wherein said processor is further configured to:
arrange the scheduled task in a schedule list;
control said output unit to present in the graphical user interface a chat list that contains an option corresponding to the schedule list and that is created by the IM software;
when it is determined that the option corresponding to the schedule list is selected, control said output unit to present the schedule list in the graphical user interface, presentation of the schedule list containing contents of the scheduled task which include the message to be sent to the chat session at the scheduled time and further containing an edit icon which corresponds to the scheduled task;
when it is determined that the edit icon corresponding to the scheduled task is selected, control said output unit to present the date-and-time picker in the graphical user interface for resetting the scheduled time; and
when it is determined that the scheduled time has been reset via the date-and-time picker, update the scheduled time corresponding to the scheduled task.

9. The IM device as claimed in claim 6, wherein said processor is further configured to:
control said output unit to present a repeat icon on the date-and-time picker;
control said output unit to present a repetition period picker in the graphical user interface for designating a repetition period when it is determined that the repeat icon is selected; and
send the message corresponding to the scheduled task to the chat session when it is determined that the scheduled time corresponding to the scheduled task has arrived or whenever a repetition period has elapsed after the scheduled time.

10. A computer program product for scheduled transmission of a message, the computer program product comprising a non-transitory computer readable storage medium having instant messaging (IM) software stored therewith, the IM software, when being executed by a computer, causing the computer to:
provide a graphical user interface which includes a chat interface for a chat session, the chat interface being established in advance by the IM software;
present a date-and-time picker in the graphical user interface for setting a scheduled time when it is determined that a message is inputted in an input field of the chat interface and that a prearrangement icon of the chat interface is selected;
when it is determined that the scheduled time has been set, generate a scheduled task, the scheduled task corresponding to sending the message at the scheduled time; and
send the message corresponding to the scheduled task to the chat session when it is determined that the scheduled time corresponding to the scheduled task has arrived.
